(19) United States
(12) Patent Application Publication
(10) Pub. No.: US 2008/0226135 A1
(43) Pub. Date: Sep. 18, 2008

(54) INCREMENTAL RECOGNITION

(75) Inventors: Jean-Francois Mainguet, Grenoble (FR); Bruno Charrat, Saint Egreve (FR); Alain Chambron, Saint Egreve (FR)

Correspondence Address: FISH & RICHARDSON P.C., PO BOX 1022, MINNEAPOLIS, MN, 55440-1022, US

(73) Assignee: ATMEL CORPORATION, Fribourg (CH)

(21) Appl. No.: 11/684,778

(22) Filed: Mar. 12, 2007

(51) Int. Cl. G06K 9/00

(52) U.S. Cl. 382/115

(57) ABSTRACT

Biometric data can be received from a biometric sensor responsive to a physical characteristic stimulus occurring during a sensing event. An incremental recognition process on the biometric data received can be executed prior to the termination of the sensing event.

### BACKGROUND

This disclosure relates to sensing devices.

Sensor devices can include sensor manufactures that can transduce one form of energy into another, e.g., charged coupled devices, piezoelectric materials, or pyroelectric materials. Typically such sensor devices include basic control circuitry, e.g., amplifiers, analog-to-digital converters, input/output circuitry, and the like, on device (e.g., on-chip).

The data output by the sensor device can be processed by a processing device in communication with the sensor device. The processing device ears, for example, process the data received from the sensor device to reconstruct a fingerprint image and attempt to authenticate or identify the fingerprint by executing a recognition process.

### SUMMARY

Disclosed herein are systems and methods of incremental recognition, in one implementation, biometric data can be received from a biometric sensor responsive to a physical characteristic stimulus. If an amount of biometric data received exceeds a first threshold, representative data from the biometric data can be generated. The first threshold corresponds to an amount of biometric data that is less than an amount of total biometric data to be generated by the biometric sensor in response to the physical characteristic stimulus.

In another implementation, a biometric sensor can be configured to generate biometric data in response to a physical characteristic stimulus, and a data store can be configured to receive and store the biometric data. A processing subsystem can be configured to generate representative data from the biometric data stored in the data store in response to determining that the amount of biometric data stored in the data store exceeds a first threshold, and to store the representative data in the data store. The first threshold corresponds to an amount of biometric data that is less than the total biometric data to be generated by the biometric sensor in response to the physical characteristic stimulus.

In another implementation, a biometric sensor can be configured to generate biometric data in response to a physical characteristic stimulus. A butler can be configured to receive and store up to a maximum capacity of biometric data, and a data store can be configured to store representative data. A processing subsystem can be configured to generate the representative data from the biometric data stored in the buffer after the amount, of biometric data stored in the buffer exceeds a first threshold and store the representative data in the data store. The first threshold corresponds to an amount of biometric data that, is less than the total biometric data to be generated by the biometric sensor in response to the physical characteristic stimulus.

In another implementation, fingerprint data responsive to a fingerprint stimulus is received. Fingerprint minutiae from the fingerprint data can be generated in response to determining that the amount of fingerprint data exceeds a first threshold, and a search for a match based on the fingerprint minutiae can be conducted. The first threshold corresponds to an amount of fingerprint data that is less than the total fingerprint data to be generated in response to the fingerprint stimulus.

In another implementation, biometric data can be received from a biometric sensor in response to a physical characteristic stimulus occurring during a sensing event. A recognition process on the biometric data received can be executed prior to the termination of the sensing event.

Aspects of the invention can include none, one or more of the following advantages. A recognition process can be defined that is predicated on receiving less than an entire data representation of a sensing event, e.g., an entire data representation of a swiping of a fingerprint. Accordingly, a user may not be required to wait for reception and processing of an entire data representation of a sensing event before a validation is returned.

### BRIEF DESCRIPTION OF THE DRAWINGS

FIG. 1 is a block diagram of an example sensor device system.

FIG. 2 is an illustration of example representative data points in a fingerprint image.

FIG. 3 is a timing diagram of an example incremental recognition process.

FIG. 4 is a timing diagram of another example incremental recognition process.

FIG. 5 is a block diagram of another example sensor device system.

FIG. 6 is a flow diagram of an example incremental recognition process.

FIG. 7 is a flow diagram of another example incremental recognition process.

FIG. 8 is a flow diagram of another example incremental recognition process.

FIG. 9 is a flow diagram of an example biometric data storing process.

FIG. 10 is a flow diagram of another example incremental recognition process.

FIG. 11 is a flow diagram of another example incremental recognition process.

### DETAILED DESCRIPTION

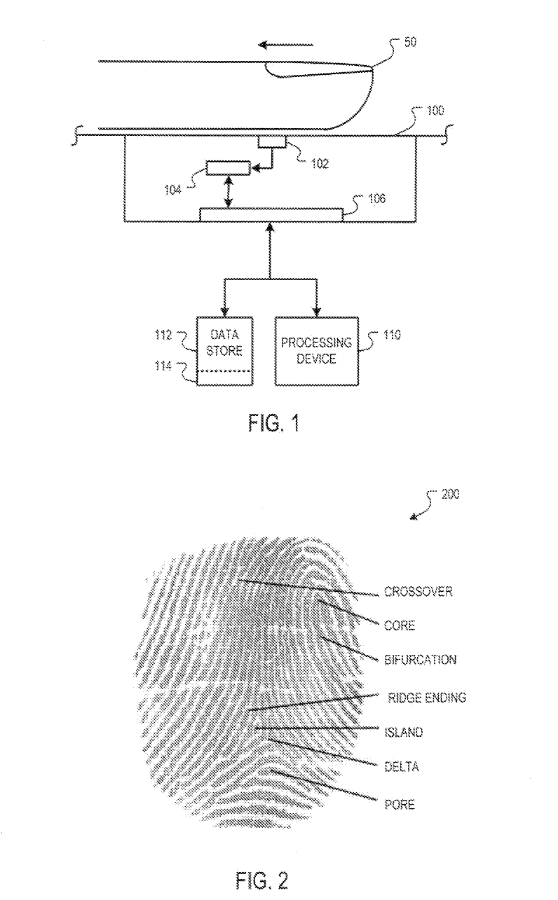

FIG. 1 is a block diagram of an example sensing device 100. The example sensing device 100 can be a biometric sensing device configured to sense a biometric stimulus, such as the swiping of a finger 50 to read a corresponding fingerprint, for example. The sensing device 100 can implement a different type of sensor, however.

The sensing device 100 can include a sensor manufacture 102 coupled to a processing circuit 104 and an input/output circuit 106. By way of example, reference will he made to a sensor manufacture 102 that is of the form of a fingerprint sensor. Other forms of sensors are possible. As a stimulus is provided to (e.g., a finger 50 is pressed and/or swiped on) the sensor manufacture 102, the sensor manufacture 102 generates electrical signals based on a characteristic of the stimulus (e.g., the fingerprint on the finger 50). The source material of the sensor manufacture 102 can, for example, comprise a layer of polyvinylidene fluoride (PVDF), polyvinylidene fluoride, trifluoroethylene (PVDF-TrFE), polyvinylidene cyanide-vinyl acetate (PVDCN-VAc), or some other transducing material that can produce an electric charge in response to a physical stimulus, such as a biometric stimulus.

The electrical signals output by the sensor manufacture 102 are processed by the processing circuit 104. In one implementation, the processing circuit 104 comprises an analog to digital converter and a latch. Other processing circuits can also be used. The output of the processing circuit 104 can be a digital representation of a biometric, e.g., a fingerprint. The biometric data can be provided to an input/output circuit 106, which, in turn, provides the biometric data to a processing device 110, such as a microprocessor executing filtering and recognition algorithms. In one implementation, a data store 112 can be coupled to the input/output circuit 106 and the processing device 110 and configured to store the biometric data received from the sensor device 100.

In one implementation, the sensor manufacture 102 can be of such proportion to receive only a partial stimulus (e.g., a partial area of the finger 50). In one implementation, the finger 50 is swiped across the sensor manufacture 102. The example sensing device 100 can generate multiple instances of biometric data per second, with each instance corresponding to a partial image of a stimulus (e.g., fingerprint). The multiple instances of biometric data can be processed by the processing device 110 to detect overlapping data and to generate a complete image of the stimulus (e.g., fingerprint of the finger 50). Sensor manufactures 102 of different dimensions and different biometric data collection processes can also be used.

In another implementation, the processing device 110 and data store 112 can be integrated in the sensor device 100, e.g., located on the same substrate as the sensor manufacture 102. Other architectures for the sensor device 100 can also be used.

The processing device 110 can execute a matching algorithm on the biometric data to determine whether a corresponding reference sample (e.g., fingerprint) can be identified or authenticated. The matching algorithm can, for example, perform a comparison of the biometric data received to one or more reference data sets, e.g., fingerprint templates. The reference data sets can, for example, be stored during a biometric enrollment process in which one or more users provide a biometric stimulus, e.g., a fingerprint application to a sensor device. An authentication or identification can be made if a match between the biometric data and one or die reference data sets is identified.

In one implementation, the matching algorithm is a correlation-based algorithm, in which a match is performed by superimposing two portions of images (e.g., fingerprint images) and computing the correlation between corresponding pixels. In one implementation, the fingerprint template for a correlation-based algorithm can be a finger image generated during an enrollment, e.g., pixel data output by the sensor device 100.

In another implementation, the matching algorithm can be a representative data-based algorithm, in which representative data generated from the biometric data can be compared to one or more representative data templates. In one implementation, the representative data can be derived fingerprint data, e.g., minutiae points. FIG. 2 is an illustration of example representative data points, e.g., minutiae points, in a fingerprint image 200. Example minutiae points include crossover points, core points, bifurcation points, ridge ending points, island points, delta points, and pore points. Other minutiae points can also be used.

In this implementation, the processing device 110 can process the biometric data to generate the representative data. The representative data can, for example, be minutiae points that are mapped to a relative placement in tire fingerprint. The representative data extracted from the biometric data can be compared to one or more stored templates, e.g., one or more reference files of minutiae date, to determine whether the representative data matches any one of the stored templates.

Typically the representative data requires less storage than a corresponding conventional image (e.g., fingerprint image). A portion of the data store 114 of the sensor device 100 can be used to store one or more templates for one or more fingerprints or to store fingerprint images for one or more fingerprints.

In one implementation, the processing device 110 can perform an incremental recognition process, e.g., a matching algorithm on increments of the biometric data or increments of the representative data, prior to the termination of the sensing event, e.g., prior to the termination of a swiping of the finger 50 across the sensor manufacture 102. Accordingly, if a match is identified on an incremental set of data, an identification or authentication, can occur before the termination of the sensing event. The incremental recognition process can continue until a match is found on an incremental set of data, or until after the termination of the sensing event, after which the recognition process will perform a final recognition attempt on the final incremental set of data, e.g., a complete set of either biometric data or representative data.

Other pattern-recognition algorithms utilizing image data or representative data can also be used.

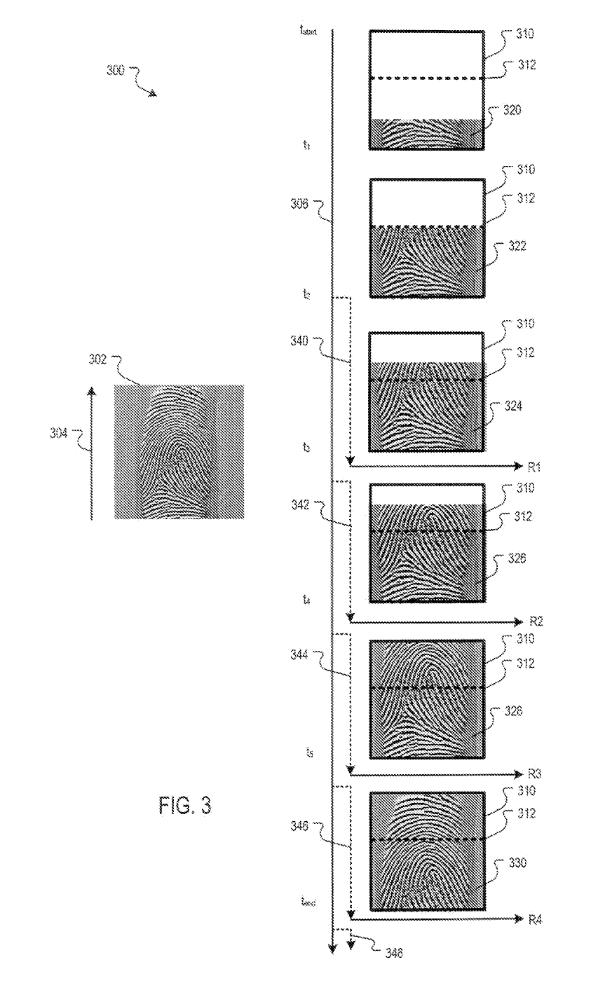

FIG. 3 is a timing diagram of an example incremental recognition process 300. The incremental, recognition process 300 can, for example, be implemented to facilitate an identification or authentication prior to a termination, of a sensing event, e.g., prior to the termination of a fingerprint swipe on the example sensing device 100 of FIG. 1.

A complete fingerprint 302 can be received by the sensing device 100 by swiping the fingerprint 302 over the sensor manufacture 102 in the direction of the arrow 304. A corresponding arrow 306 represents incremental data received during the duration of the sensing event, e.g., from tₛₜₐᵣₜ to t_{end}.

A data store allocation 310, which can, for example, be implemented in the data store 112 of the sensor device 100 can be configured to receive the biometric data responsive to the biometric stimulus of the finger swipe, in one implementation, the data store allocation 310 can, for example, be configured to store only a subset of an entire fingerprint image, e.g., 75% of an average fingerprint image.

A first threshold 312 can, for example, correspond to a minimum amount of biometric data required to carry out a recognition process, e.g., a matching algorithm. In one implementation, the first threshold can be based on a confidence threshold. In an implementation, the confidence threshold corresponds to a false match probability, e.g., an amount of biometric data required to ensure that the probability of a false match is less than 0.5%, for example. Other confidence threshold schemes can also be used.

At the time tₛₜₐᵣₜ, the data store allocation 310 is empty, and the swiping of the fingerprint 302 across the sensor manufacture 102 begins. After a processing delay, a first set 320 of biometric data is stored in the data store allocation 310 at the time t₁. The first set 320 of biometric data can for example, correspond to one or more packets of biometric data generated by the sensor device 100. Because the first set 320 of biometric data does not meet or exceed the first threshold 312, however, a recognition process is not performed.

As time elapses, additional biometric data is stored in the data store allocation 310, resulting in a second set 322 of stored biometric data. As shown in FIG. 3, the second set 322 of biometric data meets die first threshold 312, and thus a first recognition process 340 is performed by a processing device, such as the processing device 110. The first recognition process 340 outputs a result, R1, indicating whether a match is detected, e.g., whether the fingerprint 302 is authenticated or identified. Upon detecting a match, the recognition process 300 can terminate.

While the first recognition process 340 is executing, additional biometric data can be stored in the data store allocation 310, resulting in a third set 324 of stored biometric data. If the result R1 does not indicate a match, then another execution of a recognition process, e.g., a second recognition process 342, can be performed on the third set 324 of stored biometric data.

While the second recognition process 342 is executing, additional biometric data can be stored in the data store allocation 310, resulting in a fourth set 326 of stored biometric data. If the result R2 does not indicate a match, then another execution of a recognition process, e.g., a third recognition process 344 can be performed on the fourth set 326 of stored biometric data.

While the third recognition process 344 is executing, additional biometric data can be stored in the data store allocation 310, resulting in a fifth set 328 of stored biometric data. In the implementation shown in FIG. 3, the firth set 328 of biometric data reaches a storage capacity of the data store allocation 310. If the result R3 does not indicate a match, then another execution of a recognition process, e.g., a fourth recognition process 346, can be performed on the fifth set 328 of stored biometric data.

While the fourth recognition process 346 is executing, additional biometric data can be stored in the data store allocation 310, resulting in a sixth set 330 of stored biometric data. The sixth set 330 of stored biometric data, however, includes only the most recent biometric data received from the sensor device 100. As the amount of biometric data has reached the capacity of the data store allocation 310, the most former data stored in the data store allocation, e.g., data that initially defined the second set 322 of biometric data, can be deleted or overwritten.

The process 300 continues until a match is identified or no additional biometric data is provided, e.g., alter termination of the sensing event. For example, if the sixth set 330 of biometric data is the final set of biometric data, and if the result R4 does not indicate a match, then a final execution of a recognition process, e.g., a fifth recognition process 348, can he performed on the sixth set 330 of stored biometric data.

In another implementation, the data store allocation 310 can, for example, be of sufficient memory to store an entire finger print image. Each respective recognition process can thus be performed on incrementally increasing amounts of biometric data. Accordingly, the last recognition process will be performed on the largest set of biometric data.

In yet another implementation, the process 300 can be selectively enabled and disabled by a user.

Example recognition processes can include correlation-based matching algorithms and minutiae-based matching algorithms. Other recognition processes that can process incremental sets of biometric data can also be used.

In another implementation, at the termination of an unsuccessful recognition process, e.g., the first recognition process 340, the process 300 can determine whether sufficient additional data has been stored, e.g., addition data added to the second set 322 of biometric data, before executing another recognition process. Another recognition process is executed only if an amount of additional data has been stored that is sufficient to possibly change the outcome of another execution of the recognition process.

In another implementation, recognition processes can be repeatedly performed until a match is found. In yet another implementation, multiple threads perform a recognition process on incremental sets of data as soon as additional data has been stored that is sufficient to possibly change the outcome of another execution of the recognition process in a new thread.

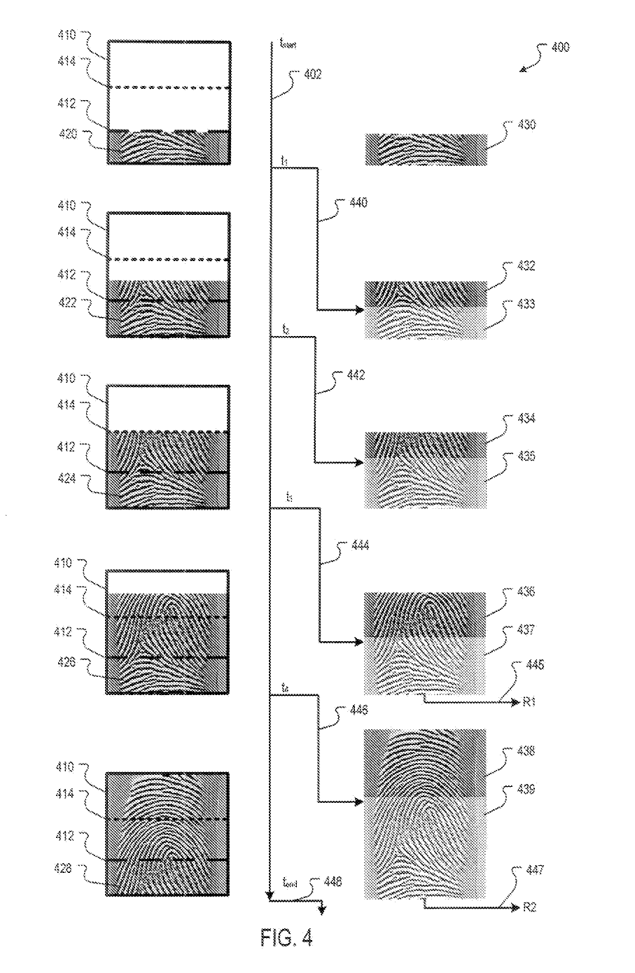

FIG. 4 is a timing diagram of another example incremental recognition process 400. The incremental recognition process 400 can, for example, be implemented to facilitate an identification or authentication prior to a termination of a sensing event, e.g., prior to the termination of a fingerprint swipe on the example sensing device 100 of FIG. 1.

A complete fingerprint can be received by the sensing device 100 by swiping the fingerprint over the sensor manufacture 102, and the sensing device 100 can generate corresponding biometric data during a processing period, such as the processing period represented by the arrow 402.

A data store allocation 410, which can, for example, be implemented, in the data store 112 of the sensor device 100, can be configured to receive the biometric data responsive, for example, to the biometric stimulus of the finger swipe. In one implementation, the data store allocation 410 can, for example, be configured, to store only a subset of an entire fingerprint image, e.g., 60% of an average fingerprint image.

A first threshold 412 can, for example, correspond to a minimum amount of biometric data required to generate representative data. In one implementation, the representative data can be fingerprint minutiae data, and the minimum amount of biometric data can correspond to an amount of fingerprint image data required to extract corresponding minutiae data.

A second threshold 414 can, for example, correspond to a minimum amount of biometric data required to carry out a recognition process, e.g., a matching algorithm. In one implementation, the second threshold 414 can be based on a confidence threshold. In an implementation, the confidence threshold corresponds to a true match probability, e.g., an amount of biometric data required to ensure that the probability of a true match to a matching template is greater than 50%, for example. Other confidence threshold schemes can also be used.

At the time tₛₜₐᵣₜ, the data store allocation 410 is empty, and the swiping of the fingerprint across die sensor manufacture 102 begins. After a processing delay, a first set 420 of biometric data is stored in the data store allocation 410 at time t_{J}. The first set 320 of biometric data can, for example, correspond to one or more packets of biometric data generated by the sensor device 100.

As shown hi FIG. 4, the first set of biometric data 420 meets the first threshold, and thus a first representative data process 440 is executed to generate representative data. The amount of biometric data processed to generate corresponding representative data is shown on the right side of the timing diagram. For example, at the time t₁, the unprocessed biometric data 430 corresponds to the first set 420 of biometric data.

Because the first set 420 of biometric data does not meet or exceed the second threshold 414, however, a recognition process is not performed. Furthermore, while the first representative data process 440 is executing, additional biometric data is stored in the data store allocation 410, resulting in a second set 422 of stored biometric data. As shown in FIG. 4, the second set 422 of biometric data does not meet the second threshold 414, and thus a recognition process is not performed.

At the completion of the first representative data process 440, representative data 433 corresponding to the first set 420 of biometric data is generated. A second representative data process 442 is executed to generate additional representative data. Accordingly, approximately at die time t₂, the unprocessed biometric data 432 substantially corresponds to the amount of biometric data received, between the time t₁ and t₂.

While the second representative data process 442 is executing, additional biometric data is stored in the data store allocation 410, resulting in a third set 424 of stored biometric data. As shown in FIG. 4, the third set 424 of biometric data meets the second threshold 414. At the completion of the second representative data process 442, representative data 435 corresponding to the second set 422 of biometric data is generated. A third representative data process 444 is executed to generate additional representative data. Accordingly, approximately at the time t₃, the unprocessed biometric data 434 substantially corresponds to the amount of biometric data received between the time t₂ and t₃.

While the third representative data process 444 is executing, additional biometric data is stored in the data store allocation 410, resulting in a fourth set 426 of stored biometric data. At the completion of the third representative data process 444, representative data 437 corresponding to the third set 424 of biometric data is generated. As the third set 424 of biometric data met the second threshold 414, a first recognition process 445 can be performed on the corresponding representative data 437. Additionally, a fourth representative data process 446 can be performed. Thus, approximately at the time t₄, the unprocessed biometric data 436 substantially corresponds to the amount of biometric data received between the times t₃ and t₄.

If the output R1 of first recognition process 445 identifies a match, the process 400 can terminate; otherwise, the process 400 can continue. If the process 400 continues, additional biometric data is stored in the data store allocation 410, resulting in a fifth set 428 of stored biometric data. At the completion of the fourth representative data process 446, representative data 439 corresponding to the fourth set 426 of biometric data is generated, and a second recognition process 447 can be performed on the representative data 439. Additionally, a fifth representative data process 448 can be performed. Thus, approximately at the time t_{end}, the unprocessed biometric data 438 substantially corresponds to the amount of biometric data received between the times t₄ and t_{end}.

The process 400 continues until a match is identified or no additional biometric data is provided, e.g., after termination of (he sensing event at t_{end}. For example, if the fifth set 428 of biometric data is the final set of biometric data, and if the result R2 does not indicate a match, then a final execution of a recognition process, e.g., a third recognition process 448, can be performed on a final set of representative data generated by the fifth representative data process 448, and that corresponds to the fifth set 428 of biometric data.

If additional biometric data are received after the first set 428 of biometric data, then subsequent sets of biometric data need only includes the most recent biometric data received from the sensor device 100. As the amount of biometric data has reached the capacity of the data store allocation 410, the most former data stored in the data store allocation, e.g., data that initially defined the first set 420 of biometric data, can be deleted or overwritten. In another implementation, the data store allocation 410 can be sized to store all sets of data associated with, a representative stimulus.

In one implementation, the data store allocation 410 can be configured to store an amount of biometric data at least equal to the first threshold 412 and any additional biometric data required to be buffered between subsequent representative data processes, e.g., an amount of biometric data defined by the second set 422 of biometric data. Other amounts of biometric data can also be stored.

In another implementation, the representative data is stored in a separate data store, e.g., in a data store address range outside of the data, store allocation 410, or a cache memory associated with the processing device 110, for example.

In another implementation, the second threshold 414 can he based on a corresponding amount of representative data, e.g., minutiae data. For example, the second threshold 414 can be measured with respect to the amount of minutiae data stored in a data store, e.g., the second threshold 414 can correspond to the amount of minutiae data defined by the third set 427 of minutiae data. Other confidence schemes can be used to determine the first and second thresholds.

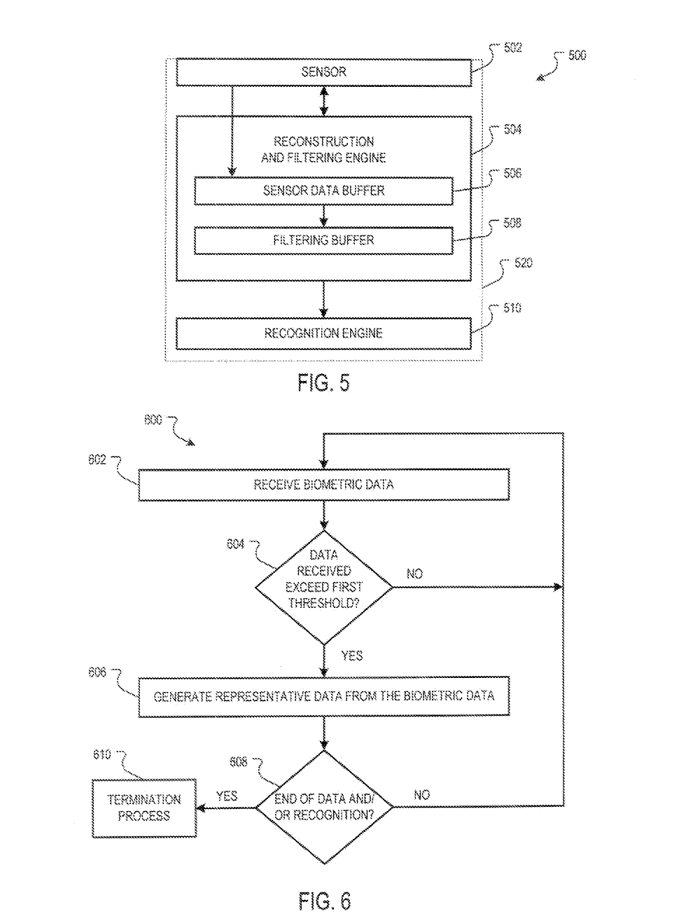

FIG. 5 is a block diagram of another example sensor device system 500. The example sensor device system 500 includes a sensor 502, a reconstruction and filtering engine 504, and a recognition engine 510.

The sensor 502 can, for example, be a biometric sensor, such as a fingerprint sensor, and can communicate biometric data to the reconstruction, and filtering engine 504. The reconstruction and filtering engine 504 can, for example, include a sensor data buffer 506 and a filtering buffer 508. The sensor data buffer 506 can, for example, be configured to store biometric data received from the sensor device 502, and the filtering buffer 508 can, for example, be configured to store representative data, e.g., minutiae, based on the biometric data. The recognition engine 510 can, for example, be configured to perform incremental recognition processes on the representative data stored in die filtering buffer.

In one implementation, the sensor 502, the reconstruction and filtering engine 504, and the recognition engine 510 can be implemented on-chip, e.g., on a single substrate, as indicated by the phantom block 520. In another implementation, the sensor 502, the reconstruction and filtering engine 504 and the recognition engine 510 can be implemented as separate devices. Other implementation architectures can also be used.

FIG. 6 is a flow diagram of another example incremental recognition process 600. The example process 600 can, for example, be implemented in the sensor device 100, processing device 110 and data store 112 of FIG. 1, or in the sensor device 502, reconstruction and filtering engine 504 and recognition engine 510 of FIG. 5, or in other biometric processing systems.

Stage 602 receives biometric data. For example, the processing device 110 and the data store 112 can receive biometric data from the sensor device 100, or the reconstruction and filtering engine 504 can receive biometric data from the sensor device 502.

Stage 604 determines if the amount of biometric data received exceeds a first threshold. For example, the processing device 110 of FIG. 1 or the reconstruction and filtering engine 504 of FIG. 5 can determine whether the amount of biometric data received exceeds a first threshold that corresponds to an amount of biometric data required to generate representative data.

If the amount of biometric data received does not exceed the first threshold, die process 600 returns to stage 602. For example, the processing device 110 and the data store 112 can receive additional biometric data from the sensor device 100, or the reconstruction and filtering engine 504 can receive additional biometric data from the sensor device 502.

If, however, the amount of biometric data received does exceed the first threshold, then stage 606 generates representative data from the biometric data. For example, the processing device 110 of FIG. 1 or the reconstruction and filtering engine 504 of FIG. 5 can generate representative data from the stored biometric data, e.g., minutiae from a portion of a fingerprint image, or some other derived fingerprint data.

Stage 608 determines whether no additional biometric data is to be received and/or if a recognition has occurred. For example, the processing device 110 of FIG. 1 or the reconstruction and filtering engine 504 and/or the recognition engine 510 of FIG. 5 can determine whether a sensing event has ended, e.g., the end of a fingerprint swipe, based on data received from the sensor devices 100 or 502, respectively, or can determine whether a recognition, e.g., an authentication or an identification, has occurred.

If additional biometric data is to be received and if a recognition has not occurred, then the process 600 returns to stage 602. If, however, no additional biometric data is to be received or if a recognition has occurred, then stage 610 executes a termination process. For example, the processing device 110 of FIG. 1 or the recognition engine 510 can execute a final recognition process on the biometric data or the representative data if no additional biometric data is to he received. If a recognition does occur, e.g., an authentication or an identification, then a secured termination process 610, such as enabling access to a computer, can, for example, be executed. If a recognition does not occur, then a secured termination process 610, such as disabling access to a computer, can, for example, be executed.

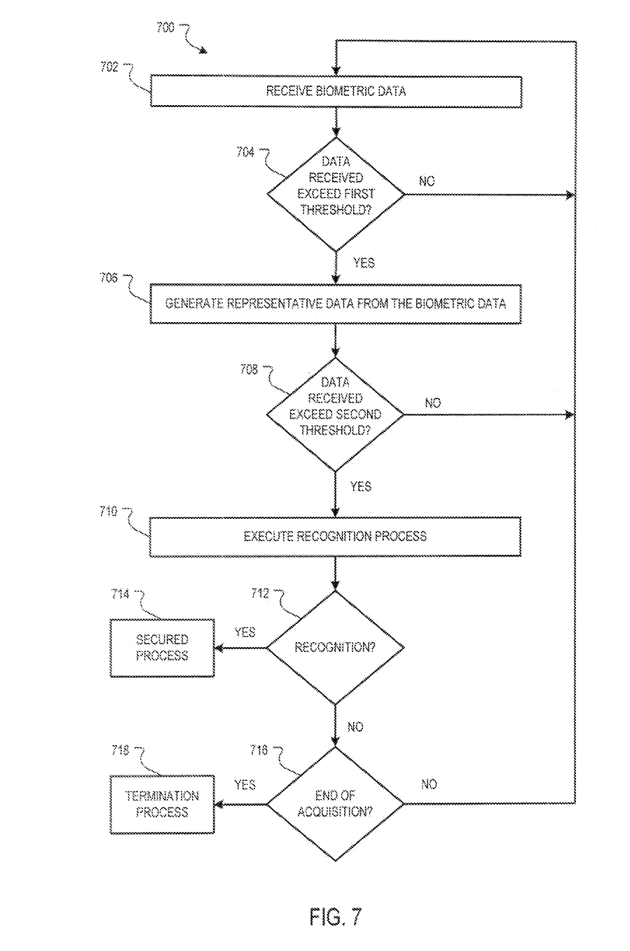

FIG. 7 is a flow diagram of another example incremental recognition process 700. The example process 700 can, for example, be implemented in the sensor device 100, processing device 110 aid data store 112 of FIG. 1, or in the sensor device 502, reconstruction and filtering engine 504 and recognition engine 510 of FIG. 5, or in other biometric processing systems.

Stage 702 receives biometric data. For example, the processing device 110 and the data store 112 can receive biometric data from the sensor device 100, or the reconstruction and filtering engine 504 can receive biometric data from the sensor device 502.

Stage 704 determines if the amount of biometric data received exceeds a first threshold. For example, the processing device 110 of FIG. 1 or the reconstruction and filtering engine 504 of FIG. 5 can determine whether the amount of biometric data received exceeds a first threshold that corresponds to an amount of biometric data required to generate representative data.

If the amount biometric data received does not exceed die first threshold, then the process 700 returns to stage 702. For example, the processing device 110 and the data store 112 can receive additional biometric data from the sensor device 100, or the reconstruction and filtering engine 504 can receive additional biometric data from the sensor device 502.

If, however, the amount of biometric data received does exceed the first threshold, then stage 706 generates representative data from the biometric data. For example, the processing device 110 of FIG. 1 or the reconstruction and filtering engine 504 of FIG. 5 can generate representative data from the stored biometric data, e.g., minutiae from a portion of a fingerprint image, or some other derived, fingerprint data.

Stage 708 determines if the amount of biometric data received exceeds a second threshold. For example, the processing device 110 of FIG. 1 or the reconstruction and filtering engine 504 and/or the recognition engine 510 of FIG. 5 can determine if the amount of biometric data received meets a second threshold based on a confidence threshold, e.g., a false match probability, or a true match probability.

If the amount biometric data received does not exceed the second threshold, then the process 700 returns to stage 702. If, however, the amount of biometric data received does exceed the second threshold, then stage 710 executes a recognition process. For example, the processing device 110 of FIG. 1 or the recognition engine 510 of FIG. 5 can execute a recognition process, such as a minutiae-based matching algorithm.

Stage 712 determines whether a recognition has occurred. For example, the processing device 110 of FIG. 1 or the recognition engine 510 of FIG. 5 can generate a result indicating whether a recognition has occurred by executing the recognition process.

If a recognition has occurred, then stage 714 executes a secured process. For example, the processing device 110 of FIG. 1 or the recognition engine 510 of FIG. 5 can allow access to a secured device, such as a computer, or can allow a secured transaction, such as a commercial transaction.

If recognition has not occurred, then stage 716 determines whether an end of an acquisition event has occurred. For example, the processing device 110 of FIG. 1 or the reconstruction and filtering engine 504 and/or the recognition engine 510 can determine whether a sensing event has ended, e.g., the end of a fingerprint swipe, based on data received from the sensor devices 100 or 502, respectively.

If the end of the acquisition event has been occurred, then stage 718 executes a termination process. For example, the processing device 110 of FIG. 1 or the recognition, engine 510 of FIG. 5 can preclude access to a secured device, such as a computer, or can disallow a secured transaction, such as a commercial transaction.

If the end of the acquisition event has not occurred, then the process 700 returns to stage 702.

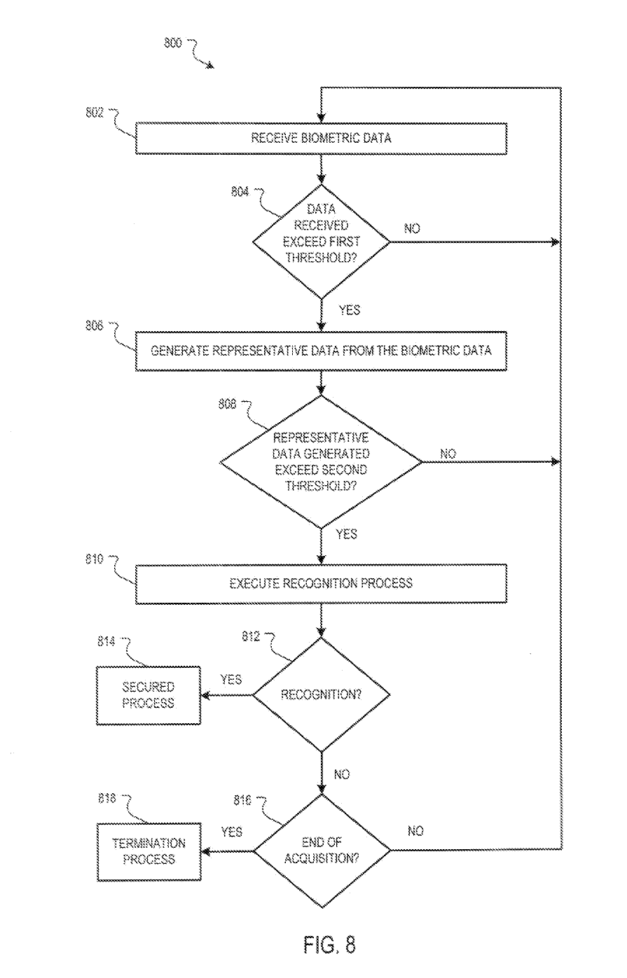

FIG. 8 is a flow diagram of another example incremental recognition process 800. The example process 800 can, for example, be implemented in the sensor device 100, processing device 110 and data store 112 of FIG. 1, or in the sensor device 502, reconstruction and filtering engine 504 and recognition engine 510 of FIG. 5, or in other biometric processing systems.

Stage 802 receives biometric data. For example, the processing device 110 and the data store 112 can receive biometric data from the sensor device 100, or the reconstruction and filtering engine 504 can receive biometric data from the sensor device 502.

Stage 804 determines if the amount of biometric data received exceeds a first threshold. For example, the processing device 110 of FIG. 1 or the reconstruction and filtering engine 504 of FIG. 5 can determine whether the amount of biometric data received exceeds a first threshold that corresponds to an amount of biometric data required to generate representative data.

If the amount biometric data received does not exceed the first threshold, then the process 800 returns to stage 802. For example, the processing device 110 and the data store 112 can receive additional biometric data from the sensor device 100, or the reconstruction and filtering engine 504 can receive additional biometric data from die sensor device 502.

If, however, the amount of biometric data received does exceed the first threshold, then stage 806 generates representative data from the biometric data. For example, the processing device 110 of FIG. 1 or the reconstruction and filtering engine 504 of FIG. 5 can generate representative data from the stored biometric data, e.g., minutiae from a fingerprint image.

Stage 808 determines if an amount of representative data generated exceeds a second threshold. For example, the processing device 110 of FIG. 1 or the reconstruction and filtering engine 504 and/or the recognition engine 510 of FIG. 5 can determine if the amount of representative data generated meets a second threshold based on a confidence threshold, e.g., a raise match probability, or a true match probability.

If the amount representative data generated docs not exceed the second threshold, then the process returns to stage 802. If, however, the amount of representative data generated does exceed the second threshold, then stage 810 executes a recognition process. For example, the processing device 110 of FIG. 1 or the recognition engine 510 of FIG. 5 can execute a recognition process, such as a minutiae-based matching algorithm.

Stage 812 determines whether a recognition has occurred. For example, the processing device 110 of FIG. 1 or the recognition engine 510 of FIG. 5 can generate a result indicating whether a recognition has occurred by executing die recognition process.

If a recognition has occurred, then stage 814 executes a secured process. For example, the processing device 110 of FIG. 1 or the recognition engine 510 of FIG. 5 can allow access to a secured device, such as a computer, or can allow a secured transaction, such as a commercial transaction.

If recognition has not occurred, then stage 816 determines whether an end of an acquisition event has occurred. For example, die processing device 110 of FIG. 1 or the reconstruction and filtering engine 504 and/or the recognition, engine 510 can determine whether a sensing event, has ended, e.g., the end of a fingerprint swipe, based on data received from the sensor devices 100 or 502, respectively,

If the end of the acquisition event has occurred, then stage 818 executes termination process. For example, the processing device 110 of FIG. 1 or the recognition engine 510 of FIG. 5 can preclude access to a secured device, such as a computer, or can disallow a secured transaction, such as a commercial transaction.

If the end of the acquisition event has not occurred, then the process 800 returns to stage 802.

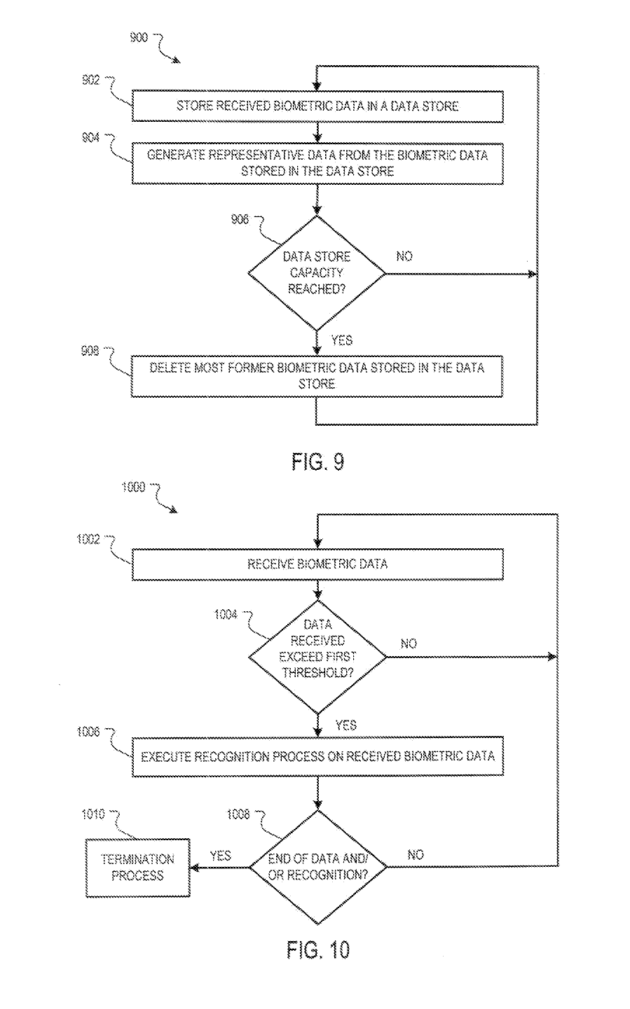

FIG. 9 is a flow diagram, of an example biometric data storing process 900. The example process 900 can, for example, be implemented in the processing device 110 and data store 112 of FIG. 1, or in the reconstruction and filtering engine 504 of FIG. 5, or in other biometric processing systems.

Stage 902 stores received biometric data in a data store. For example, biometric data generated by the sensor device 100 can be stored in the data store 112, or biometric data generated by the sensor device 502 can be stored in the sensor data buffer 506.

Stage 904 generates representative data from the biometric data stored in the data store. For example, the processing device 110 of FIG. 1 or the reconstruction and filtering engine 504 of FIG. 5 can generate representative data from the stored biometric data, e.g., minutiae from a fingerprint image.

Stage 906 determines if a data store capacity is reached. For example, the processing device 110 of FIG. 1 can determine whether the storage capacity of the data store 112 has been reached, or the reconstruction and filtering engine 504 of FIG. 5 can determine whether the storage capacity of the sensor data buffer 506 has been reached.

If the data store capacity has not been reached, then the process 900 returns to stage 902. For example, additional biometric data generated by die sensor device 100 can be stored in the data store 112, or additional biometric data generated by the sensor device 502 can be stored in the sensor data buffer 506.

If, however, the data store capacity has been reached, then, stage 908 deletes the most former biometric data stored in the data store, and the process 900 returns to stage 902. For example, the most former biometric data stored in the data store 112 can be erased or overwritten by addition biometric data received from the sensor device 100, or the most former biometric data stored in the sensor data buffer 506 can be erased or overwritten by addition biometric data received from the sensor device 502.

FIG. 10 is a flow diagram of another example incremental recognition process 1000. The example process 1000 can, for example, be implemented in the processing device 110 and data store 112 of FIG. 1, or in the reconstruction and filtering engine 504 and recognition engine 510 of FIG. 5, or in other biometric processing systems.

Stage 1002 receives biometric data. For example, the processing device 110 and the data store 112 can receive biometric data from the sensor device 100, or the reconstruction and filtering engine 504 can receive biometric data from the sensor device 502.

Stage 1004 determines if the amount of biometric data received exceeds a first threshold. For example, the processing device 110 of FIG. 1 or the reconstruction and filtering engine 504 and/or the recognition engine 510 of FIG. 5 can determine if the amount of biometric data received meets a first threshold based on a confidence threshold, e.g., a false match probability, or a true match probability.

If the amount of biometric data received does not exceed the first threshold, then the process 1000 returns to stage 1002. For example, the processing device 110 and the data store 112 can receive additional biometric data from the sensor device 100, or the reconstruction and filtering engine 504 can receive additional biometric data from the sensor device 502.

If, however, the amount of biometric data received does exceed the first threshold, then stage 1006 executes a recognition process on the received biometric data. For example, the processing device 110 of FIG. 1 or the recognition engine 510 of FIG. 5 can execute a recognition process, such as a correlation-based matching algorithm., or can generate representative data from the received biometric data and execute a minutiae-based matching algorithm, or execute some other matching algorithm.

Stage 1008 determines whether no additional biometric data is to be received aid/or if a recognition has occurred. For example, the processing device 110 of FIG. 1 or the reconstruction and filtering engine 504 and/or the recognition engine 510 of FIG. 5 can determine whether a sensing event has ended, e.g., the end of a fingerprint swipe, based on data received from the sensor devices 100 or 502, respectively, or can determine whether a recognition, e.g., an authentication or an identification, has occurred.

If additional biometric data is to be received and if a recognition has not occurred, then the process 1008 returns to stage 1002. If, however, no additional biometric data is to be received or if a recognition has occurred, then stage 1010 stage executes a termination process. For example, the processing device 110 of FIG. 1 or the recognition engine 510 can execute a final recognition process on the biometric data or the representative data if no additional biometric data is to be received. If a recognition does occur, e.g., an authentication or an identification, then a secured termination process 1010, such as enabling access to a computer, can, for example, be executed. If a recognition does not occur, then a secured termination process 1010, such as disabling access to a computer, can, for example, be executed.

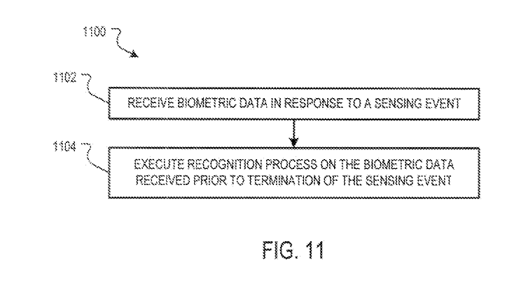

FIG. 11 is a flow diagram of another example incremental recognition process 1100. The example process 1100 can, for example, be implemented in the processing device 110 and data store 112 of FIG. 1, or in the reconstruction and filtering engine 504 and recognition engine 510 of FIG. 5, or in other biometric processing systems.

Stage 1102 receives biometric data in response to a sensing event. For example, the processing device 110 and the data store 112 can receive biometric data from the sensor device 100, or the reconstruction and filtering engine 504 can receive biometric data from the sensor device 502.

Stage 1104 executes a recognition process on the biometric data received prior to the termination of the sensing event. For example, the processing device 110 of FIG. 1 or the recognition engine 510 of FIG. 5 can execute a recognition process, such as a correlation-based matching algorithm, or can generate representative data from the receive biometric data and execute a minutiae-based matching algorithm, or execute some other matching algorithm. The execution of the recognition process can occur prior to the termination of the sensing event.

The apparatus, methods, flow diagrams, and structure block diagrams described herein can be implemented in computer processing systems including program code comprising program instructions that are executable by the computer processing system. Other implementations can also be used, such as hardware implementations or a combination of hardware and software implementations. Additionally, the flow diagrams and structure block diagrams described herein, which describe particular methods and/or corresponding acts in support of steps and corresponding functions in support of disclosed structural means, may also be utilized to implement corresponding software and/or hardware structures and algorithms, and equivalents thereof.

This written description sets forth the best mode of the invention and provides examples to describe the invention and to enable a person of ordinary skill in the art to make and use die invention. This written description docs not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A method, comprising:
receiving biometric data from a biometric sensor responsive to a physical characteristic stimulus;
determining if an amount of biometric data received exceeds a first threshold; and
generating representative data from the biometric data in response to determining that the amount of biometric data received exceeds the first threshold;
wherein the first threshold corresponds to an amount of biometric data that is less than an amount of total biometric data to be generated by the biometric sensor in response to the physical characteristic stimulus.

2. The method of claim 1, comprising:
determining if the amount of biometric data received exceeds a second threshold; and
searching for a match to the representative data in response to determining that the amount of biometric data received exceeds the second threshold.

3. The method of claim 2, comprising:
ceasing the search for a match to the representative data and the generation of representative data in response to identifying a match to the representative data.

4. The method of claim 2, wherein:
the second threshold corresponds to an amount of biometric data that is greater than the amount of biometric data corresponding to the first threshold.

5. The method of claim 2, wherein:
the physical characteristic comprises a fingerprint.

6. The method of claim 3, wherein:
the representative data comprises fingerprint minutiae.

7. The method of claim 3, wherein:
the representative data comprises pattern-recognition data.

8. The method of claim 1, comprising:
storing the biometric data received in a data store; and
generating the representative data from the biometric data stored in the data store.

9. The method of claim 8, comprising:
determining if the data store is storing a designated capacity of biometric data; and
in response to determining that the data store is storing the designated capacity of biometric data:
deleting the most former biometric data stored in the data store; and
storing the most recent biometric data received in the data store.

10. The method of claim 9, comprising:
storing the representative data in the data store.

11. The method of claim 2, comprising:
selecting a confidence threshold; and
adjusting the second threshold in response to the confidence threshold.

12. The method of claim 2, wherein:
searching for a match comprises authenticating the biometric data.

13. The method of claim 2, wherein:
searching for a match comprises identifying the biometric data.

14. The method of claim 1, comprising:
determining if the amount of representative data generated exceeds a second threshold; and
searching for a match to the representative data in response to determining that the amount of representative data generated exceeds the second threshold.

15. The method of claim 14, wherein:
the amount of representative data corresponding to the second threshold is less that, an amount of total representative data to be generated from the amount of total, biometric data to be generated by the biometric sensor in response to the physical characteristic stimulus.

16. A sensor system, comprising:
a biometric sensor configured to generate biometric data in response to a physical characteristic stimulus;
a data store in communication with the biometric sensor and configured to receive and store the biometric data;
a processing subsystem in communication with the data store and configured, to:
determine if an amount of biometric data stored in the data store exceeds a first threshold;
generate representative data from the biometric data stored in the data store in response to determining that the amount of biometric data stored in the data store exceeds the first threshold; and
store the representative data in the data store;
wherein the first threshold corresponds to an amount of biometric data that is less than the total biometric data to be generated by the biometric sensor in response to the physical characteristic stimulus.

17. The system of claim 16, wherein:
the processing subsystem is configured to determine if the amount of biometric data stored in the data store exceeds a second threshold and execute a matching algorithm on the representative data in response to determining that the amount of stored biometric data exceeds the second threshold.

18. The system of claim 17, wherein:
the processing subsystem is configured to identify a match based on the representative data during the execution of the matching algorithm and halt execution of the matching algorithm and the generation of representative data upon identifying the match.

19. The system of claim 17, wherein:
the amount of data corresponding to the second threshold is greater than the amount of data corresponding to the first threshold.

20. The system of claim 17, wherein:
the physical characteristic comprises a fingerprint.

21. The system of claim 20, wherein:
the representative data comprises fingerprint minutiae.

22. The system of any of claims 16, 17, or 18, wherein:
the processing subsystem is configured to determine if a maximum amount, of biometric data is stored in the data store, and to delete the most former biometric data stored in the data store and store the most recent biometric data in the data store upon determining that the maximum amount of biometric data is stored in the data store.

23. The system of claim 16, wherein:
the processing subsystem is configured to adjust the second threshold in response to a confidence threshold.

24. The system of claim 16, wherein:
the processing subsystem is configured to determine if the amount of stored representative data exceeds a second threshold and execute a matching algorithm on the representative data in response to determining that the amount of representative data exceeds the second threshold.

25. A sensor system, comprising:
a biometric sensor configured to generate biometric data in response to a physical characteristic stimulus;
a buffer in communication with the biometric sensor and configured to receive and store up to a maximum capacity of biometric data;
a data store configured to store representative data; and
a processing subsystem in communication with the buffer and the data store and configured to generate the representative, data from the biometric data stored in the buffer after the amount of biometric data stored in the buffer exceeds the first threshold and store the representative data in the data store;
wherein the first threshold corresponds to an amount of biometric data that is less than the total biometric data to be generated by the biometric sensor in response to the physical characteristic stimulus.

26. The system of claim 25, wherein:
the processing subsystem is configured to determine if the amount of biometric data stored in the buffer exceeds a second threshold and execute a matching algorithm on the representative data stored in the data store in response to determining that the amount of stored biometric data exceeds the second threshold.

27. The system of claim 26, wherein:
the amount of data corresponding to the second threshold is greater than the amount of data corresponding to the first threshold.

28. The system of claim 25, wherein:
the physical characteristic comprises a fingerprint; and
the representative data comprises fingerprint minutiae.

29. The system of claim 25, wherein:
the buffer is configured to replace the most former biometric data stored with the most recent biometric data received upon storing the maximum capacity of biometric data.

30. A method, comprising:
receiving fingerprint data from a biometric sensor responsive to a fingerprint stimulus:
generating fingerprint minutiae from the fingerprint data in response to determining that the amount of fingerprint data exceeds a first threshold; and
searching for a match to the fingerprint minutiae;
wherein the first threshold corresponds to an amount of fingerprint data that is less than the total fingerprint data to be generated in response to the fingerprint stimulus.

31. The method of claim 30, comprising:
searching for the match to the fingerprint minutiae in response to determining that the amount of fingerprint data received exceeds a second threshold.

32. The method of claim 30, comprising:
searching for the match to the fingerprint minutiae in response to determining that the amount of fingerprint minutiae generated exceeds a second threshold.

33. A system, comprising:
means for storing biometric data from a biometric sensor responsive to a physical characteristic stimulus;
means for generating representative data from a first threshold amount of biometric data stored in the means for storing biometric data; and
means for matching the representative data to a template in response to determining that the amount of stored biometric data exceeds a second threshold;
wherein the first threshold corresponds to an amount of biometric data that is less than the total biometric data to be generated by the biometric sensor in response to the physical characteristic stimulus.

34. A method, comprising:
receiving biometric data from a biometric sensor responsive to a physical characteristic stimulus occurring during a sensing event; and
executing a recognition process on the biometric data received prior to the termination of the sensing event.

35. The method of claim 34, wherein:
executing a recognition process on the biometric data received comprises:
generating representative data from the biometric data received; and
executing a recognition algorithm on the representative data.

36. The method of claim 34, wherein:
the sensing event comprises a fingerprint swipe.

37. A method, comprising:
receiving biometric data from a biometric sensor responsive to a physical characteristic stimulus;
determining if an amount of biometric data received exceeds a first threshold; and
executing a recognition process on the biometric data received in response to determining that the amount of biometric data received exceeds the first threshold;
wherein the first threshold corresponds to an amount of biometric data that is less than an amount of total biometric data to be generated by the biometric sensor in response to die physical characteristic stimulus.

38. The method of claim 37, wherein:
executing a recognition process on the biometric data received comprises:
generating representative data from the biometric data received; and
executing a recognition algorithm on the representative data.

39. The method of claim 37, wherein:
the recognition process comprises a minutiae-based algorithm.

40. The method of claim 37, wherein;
the recognition process comprises a correlation-based algorithm; and
wherein the first threshold corresponds to a confidence threshold.

41. A method of processing fingerprint data, comprising:
receiving fingerprint data from a fingerprint sensor in response to a fingerprint application;
determining if an amount of fingerprint data received exceeds a first threshold;
generating derived fingerprint data from the fingerprint data in response to determining that the amount of fingerprint data received exceeds the first threshold;
determining if the amount of fingerprint data received exceeds a second threshold; and
searching for & match to the derived fingerprint data in response to determining that the amount of fingerprint data received exceeds the second threshold;
wherein the first threshold corresponds to an amount of fingerprint data that is less than an amount of total fingerprint data to be generated by the fingerprint sensor in response to the fingerprint application, and the second threshold corresponds to an amount of fingerprint data that is greater than the amount of fingerprint data corresponding to the first threshold.

42. The method of claim 41, wherein:
ceasing the search for a match to the derived fingerprint data and the generation of derived fingerprint data in response to identifying a match to the derived fingerprint data.

43. The method of claim 42, comprising;
storing the fingerprint data received in a data store;
generating the derived fingerprint data from the fingerprint data stored in the data store;
determining if the data store is storing a designated capacity of fingerprint data; and
in response to determining that the data store is storing the designated capacity of fingerprint data:
deleting the most former fingerprint data stored in the data store; and
storing the most recent fingerprint data received in the data store.

44. The method of claim 41, wherein:
the derived fingerprint data comprises fingerprint minutiae data.
